(19) United States
(12) Patent Application Publication
(10) Pub. No.: US 2024/0427634 A1
(43) Pub. Date: Dec. 26, 2024

(54) CONTAINER SCHEDULING BASED ON SPACE-FILLING CURVES

(71) Applicant: International Business Machines Corporation, Armonk, NY (US)

(72) Inventor: Nikolai Baudis, Aichwald (DE)

(21) Appl. No.: 18/337,738

(22) Filed: Jun. 20, 2023

(51) Int. Cl. G06F 9/50; G06F 16/2457

(52) U.S. Cl. CPC G06F 9/5016; G06F 16/24575

(57) ABSTRACT

A method includes employing a plurality of container controllers to receive a plurality of container requests, scheduling containers onto nodes that are available for container creation, storing information pertaining to each of the nodes in a node score database, the information including at least a single score value computed by using space-filling curves (SFCs), and finding a node with an optimal score by performing a range search to schedule a container of the containers to the node with the optimal score.

### BACKGROUND

The present invention relates generally to serverless cloud computing, and more specifically, to container scheduling based on space-filling curves and a multidimensional resource model.

In serverless cloud computing, efficient creation and management of computing resources such as containers, which are used to run customer workload, is important to overall scalability and performance. These resources are usually created on worker nodes, that is, a set of virtual or physical servers. Additional containers have to be created on demand when executing workload or when scaling up in advance in order to satisfy an increase in customer workload. Container creation requests have to be fulfilled both quickly and efficiently. A quick response to load spikes causes them to flatten faster, while efficiently managing containers means placing them in such a manner that all containers use only a minimum amount of nodes, thus minimizing cost for the cloud provider.

If containers could be placed on suitable nodes while keeping the number of nodes at a minimum and if this decision could be made in a matter of a few milliseconds, PaaS offerings could benefit from great performance increase and cost savings.

### SUMMARY

In accordance with an embodiment, a method for container scheduling based on space-filling curves (SFCs) is provided. The method includes employing a plurality of container controllers to receive a plurality of container requests, scheduling containers onto nodes that are available for container creation, storing information pertaining to each of the nodes in a node score database, the information including at least a single score value computed by using SFCs, and finding a node with an optimal score by performing a range search to schedule a container of the containers to the node with the optimal score.

In accordance with another embodiment, a computer program product is provided, the computer program product comprising a computer readable storage medium having program instructions embodied therewith. The program instructions are executable by a computer to cause the computer to employ a plurality of container controllers to receive a plurality of container requests, schedule containers onto nodes that are available for container creation, store information pertaining to each of the nodes in a node score database, the information including at least a single score value computed by using space-filling curves (SFCs), and find a node with an optimal score by performing a range search to schedule a container of the containers to the node with the optimal score.

In accordance with yet another embodiment, a system is provided. The system includes a memory and one or more processors in communication with the memory configured to employ a plurality of container controllers to receive a plurality of container requests, schedule containers onto nodes that are available for container creation, store information pertaining to each of the nodes in a node score database, the information including at least a single score value computed by using space-filling curves (SFCs), and find a node with an optimal score by performing a range search to schedule a container of the containers to the node with the optimal score.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram of container controllers receiving container requests to schedule containers onto a set of available nodes, in accordance with an embodiment of the present invention;

FIG. 2 is a block/flow diagram showing memory, CPU, storage, container, and concurrency information related to each of the set of available nodes, in accordance with an embodiment of the present invention;

FIG. 3 is a block/flow diagram showing each of the set of available nodes represented as a single value including a combination of numbers and letters, in accordance with an embodiment of the present invention;

FIG. 4 is a block/flow diagram of a table illustrating two dimensions which represent available memory and virtual CPUs, where a single node's resources are encoded, in accordance with an embodiment of the present invention;

FIG. 5 is a block/flow diagram of a table where a range search algorithm is used, in accordance with an embodiment of the present invention;

FIG. 6 is a block/flow diagram of a table where the range search algorithm partitions the search space into rectangles, in accordance with an embodiment of the present invention;

FIG. 7 is a block/flow diagram illustrating finding an optimal node for a set of minimum resources that are needed for a container, in accordance with an embodiment of the present invention; and

FIG. 8 is a block diagram of an exemplary computer system to apply the container scheduling architecture based on space-filling curves and a multi-dimensional resource model, in accordance with an embodiment of the present invention.

Throughout the drawings, same or similar reference numerals represent the same or similar elements.

### DETAILED DESCRIPTION

Embodiments in accordance with the present invention provide methods and systems for efficiently scheduling containers onto a set of nodes. If a single score value is computed using space-filling curves (SFCs), the exemplary methods can find a node with an optimal score by performing a range search and schedule a container onto this node, each with a single, very efficient lookup or request.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

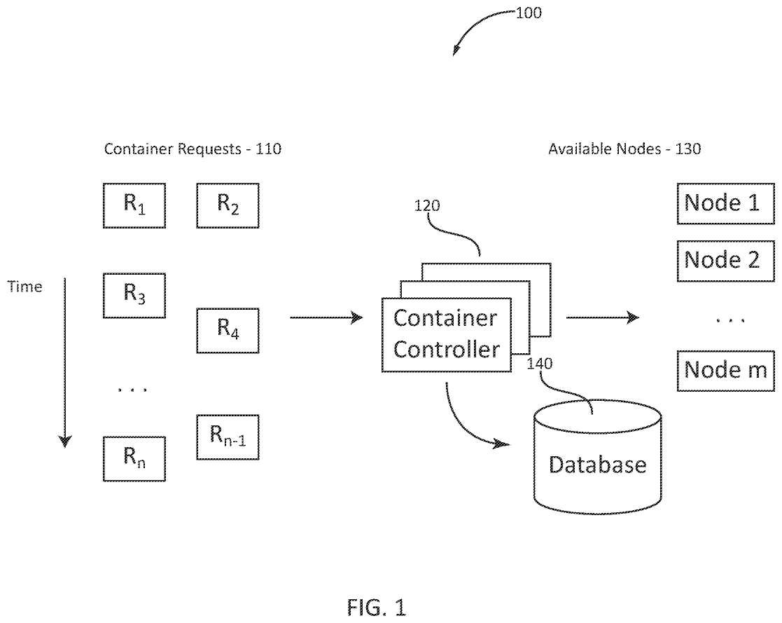

FIG. 1 is a block/flow diagram of container controllers receiving container requests to schedule containers onto a set of available nodes, in accordance with an embodiment of the present invention.

The exemplary system 100 includes one or multiple nodes 130 that are available for container creation. These nodes have resources such as memory, virtual central processing units (CPUs), etc. that have to be divided among the containers. The exemplary system 100 further includes one or multiple container controllers 120, which receive container requests 110 and, if possible, schedule each of them onto a node 130 based on available resources. The exemplary system 100 also includes a database 140 holding information regarding the nodes 130, including a score value, a quantity of available units for each resource, and metrics information such as the number of containers currently created on the node.

The exemplary algorithm includes the following steps, each of which is explained in more detail further below. For each node 130, the exemplary methods encode the available resources as well as additional metrics into a single score value and keep this updated at all times. When processing a container request 110, finding a feasible node 130 is a relatively simple range search in the database paired with an update to this node's resources and metrics. FIG. 1 shows this approach with n container requests 110 processed by three container controllers 120. Node scores are being kept in a central database 140 and containers are scheduled onto m available nodes 130.

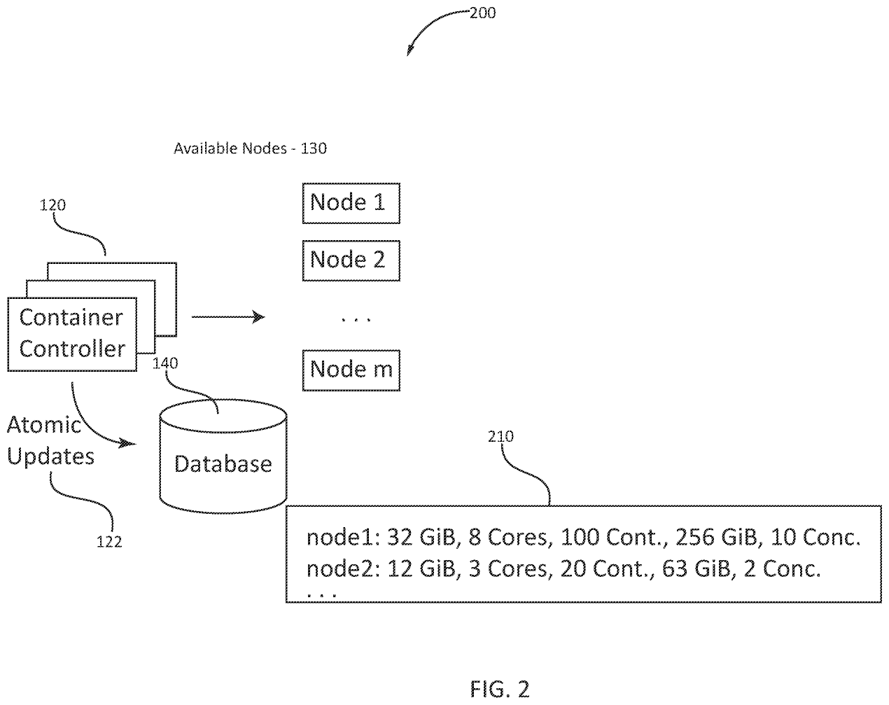

FIG. 2 is a block/flow diagram showing memory, CPU, storage, container, and concurrency information related to each of the set of available nodes, in accordance with an embodiment of the present invention.

Each node 130 can be represented based on certain parameters or variables. This node representation 210 can take on the following form, for example:

Node 1 can be represented as 32 GiB, 8 Cores, 100 Containers, 256 GiB, 10 containers.

Node 2 can be represented as 12 GiB, 3 Cores, 20 Containers, 63 GiB, 2 containers.

The parameters or variables relate to memory, CPU, container, storage, and concurrency information. Of course, one skilled in the art can contemplate other parameters and variables to incorporate into the node representation.

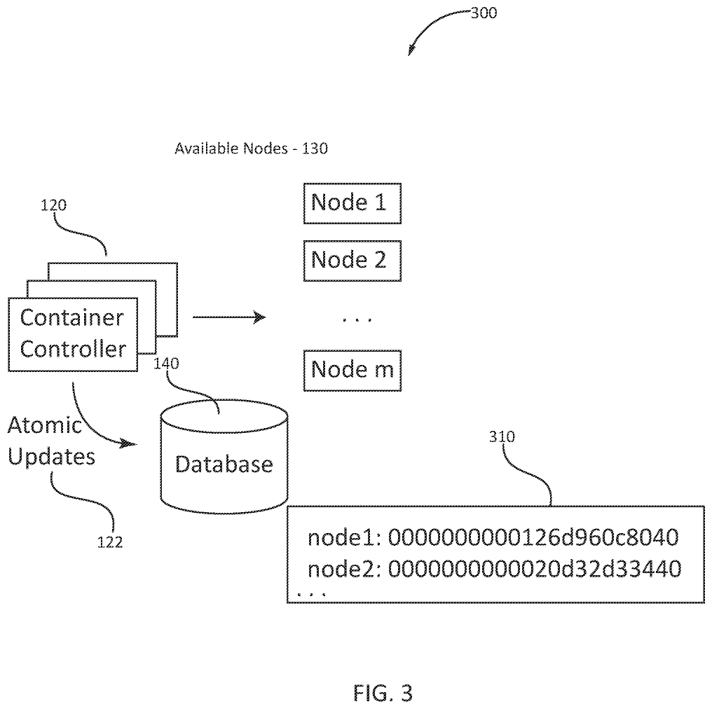

FIG. 3 is a block/flow diagram showing each of the set of available nodes represented as a single value including a combination of numbers and letters, in accordance with an embodiment of the present invention.

The nodes can further be represented as a single value 310 including a combination of numbers and letters. Element 310 is similar to element 210 of FIG. 2 but encoded using the space-filling curve (SFC). Element 310 provides a very large binary number, which is usually represented as a hexadecimal number by SFC implementations.

Regarding FIGS. 1-3, the following resources and metrics can be encoded to optimize for full utilization of a node while, at the same time, optimizing for distributing load spikes onto multiple nodes:

Physical/virtual resources of the node such as memory, virtual CPUs, and disk space. These are the resources all of the containers are going to share on the node. By using available resources and searching for the minimal node fitting the requirements of the container, the exemplary methods can maximize utilization among the cluster.

Performance metrics such as a number of total containers and a number of containers currently being created on the node. While not technically being hard limitations, introducing a certain number of slots can improve performance (i.e., container creation times) during load spikes.

Therefore, balancing multiple dimensions of computing resources well in a cloud environment will save on infrastructure cost, e.g., having a node of memory-heavy containers with most of the CPU cores unused could be scheduled differently such that infrastructure cost is minimized. In other words, if workloads can be fitted on a smaller number of nodes while keeping the same performance (e.g., without using interruptive methods such as pre-emption for moving workloads between nodes), that means a cloud provider can save costs. This is a significant practical application of the exemplary embodiments.

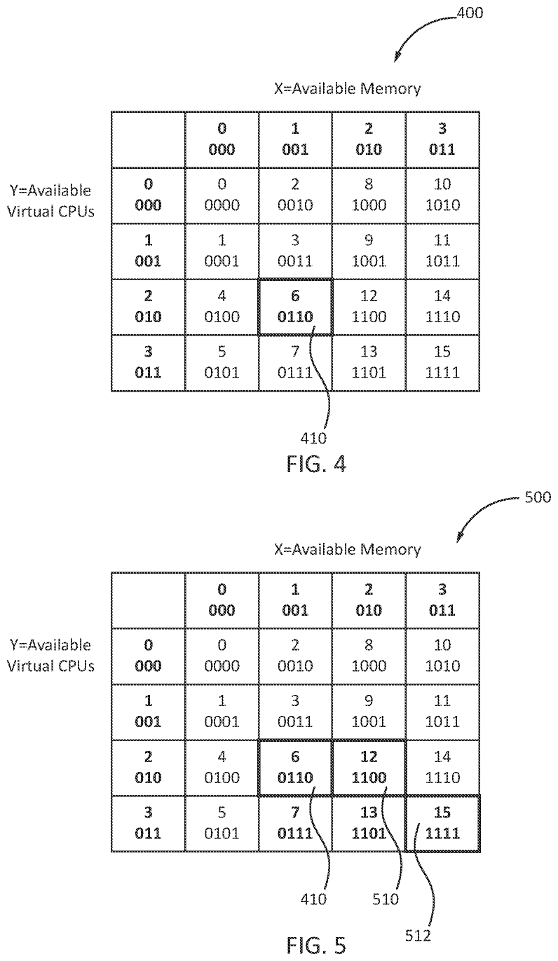

FIG. 4 is a block/flow diagram of a table illustrating two dimensions which represent available memory and virtual CPUs, where a single node's resources are encoded, in accordance with an embodiment of the present invention.

Using space-filling curves (SFCs) such as a Z-order curve, values in multiple dimensions can be mapped to a single number. Such a value is calculated by interleaving the binary representation of each dimension's value, which results in a unique number for this curve. If this is applied to the problem of finding an optimal node for container creation, the exemplary methods can represent available resources as a Z-order value and choose the lowest node that has a sufficient amount of each resource.

To compute the score of a node for n resources and metrics, i.e., in n dimensions, the bits of each dimension's value are interleaved. FIG. 4 shows an example for two dimensions which represent available memory and virtual CPUs. If a node has one unit of memory X and two units of virtual CPUs Y, the exemplary methods compute the score as follows:

X˜Y=001˜010=x₁y₁x₂y₂x₃y₃=00 01 10.

Table 400 illustrates how a single node's resources are encoded. If it has one unit of memory and two units of CPU, then the single node would be assigned a value of 6, as designated in box 410.

Tables 4-6 are meant to illustrate SFC encoding and range search. Cells in these tables do not necessarily represent nodes, but rather possible values that node resources can be encoded to. Actual database records for this would have the format <node_id>:<score> with score being one of the table cell values. A range search would then operate on the score values and return a node id.

SFCs map the multidimensional space into a one-dimensional space. Mapping the multidimensional space into a one-dimensional domain plays an important role in every application that involves multidimensional data. Multimedia databases, geographical information systems, quality of service routing, image processing, circuit design, cryptology, and graphics are examples of multidimensional applications. An SFC acts like a thread that passes through every cell element (or pixel) in the multidimensional space so that every cell is visited exactly once. Thus, space-filling curves are adopted to define a linear order for sorting and scheduling objects that lie in the multidimensional space.

FIG. 5 is a block/flow diagram of a table where a range search algorithm is used, in accordance with an embodiment of the present invention.

Encoding resources and metrics in this way allows for efficient range search inside a specified area of the Z-order curve. Using known algorithms for performing a search in a multidimensional space, the exemplary methods can iterate over areas in two, three or more dimensions inside the parameter space in order to find the optimal node for a set of minimum resources that are required for a container.

A range search is usually performed using min/max values for each dimension as input. In this instance, scheduling a container that needs two resources of at least X and Y, this could be (X, ∞), (Y, ∞), resulting in all nodes having at least the specified amount of resources available.

Range search algorithms are highly optimized to make as few lookups as possible. By narrowing down the search areas, the first lookups should result in a suitable result (e.g., a node on which the container can be scheduled). More speedup can be achieved by executing this directly in the database, e.g., with a stored procedure.

Table 500 shows how the range search algorithm operates. The input (i.e., needed resources) would be: X in interval [1,3] and Y in interval [2,3]. The range search thus only considers nodes with values 6, 7, 12, 13, 14, and 15. Table 500 has three nodes in the search range (cells 410, 510, 512 with values 6, 12, and 15, respectively).

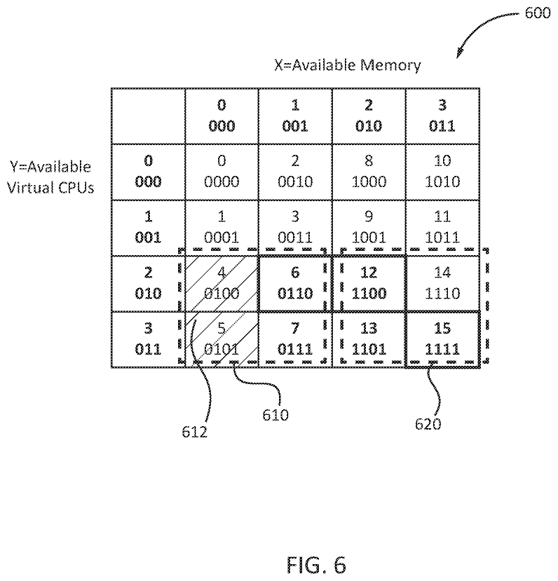

FIG. 6 is a block/flow diagram of a table where the range search algorithm partitions the search space into rectangles, in accordance with an embodiment of the present invention.

If the optimal node for a container has been found, the score entry in the database has to be updated. By including this step in the range search and atomically decrementing each resource and metric value of the node when scheduling a container, the range search will always consider the current state of each node.

Range search algorithms partition the search space in Table 600 in rectangles, which are the two dashed rectangles 610, 620 in FIG. 6. Range search algorithms also eliminate parts of the search space that are out of bounds, which are the hatched areas 612 for values 4 and 5.

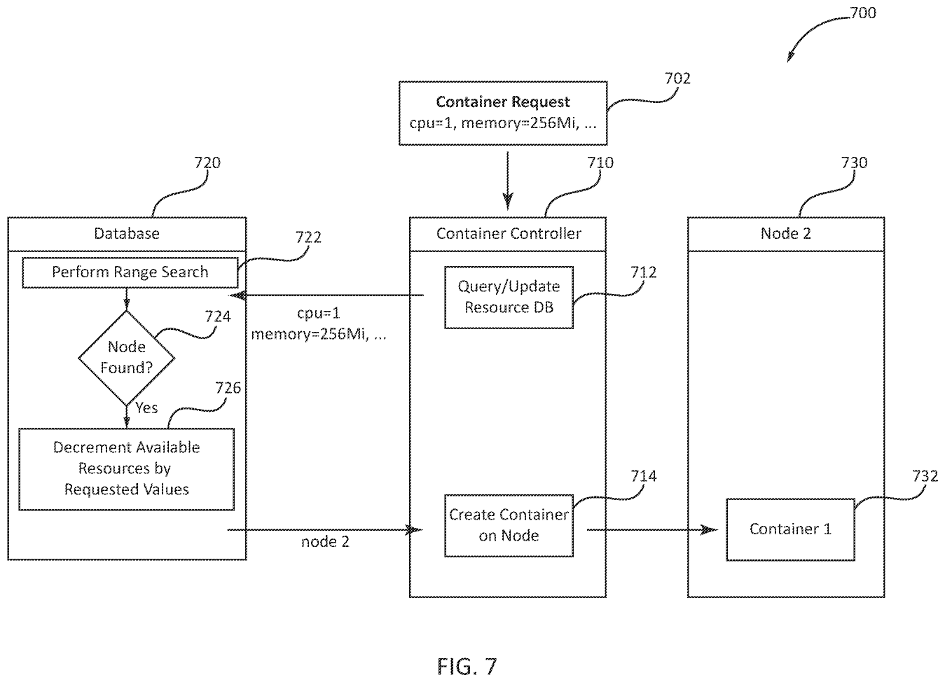

FIG. 7 is a block/flow diagram illustrating finding an optimal node for a set of minimum resources that are needed for a container, in accordance with an embodiment of the present invention.

Block/flow diagram 700 depicts a container request 702 that is made to the container controller 710. The container controller 710 includes a query/update resource database 712 and a container creator 714. The container creator 714 creates the container on a node.

The query/update resource database 712 communicates with the database 720. In the database 720, a range search 722 is performed. Then, it is determined whether a node is found at block 724. If YES, the available resources are decremented by the requested values in block 726. The container creator 714 thus creates a new container 732 on node 2 (designated as 730).

Steps 722, 724, and 726 are performed in one atomic request. The purpose of this is to serve requests from several container controllers and to keep the resource information consistent. If there is more than one container controller, performing these steps without locking in the database would result in an inconsistent data model. To maximize performance, locking could be performed on a per-node basis for the three steps in the database 720. Resources are updated as soon as an available node is found to avoid conflicts and reduce locking to a very short period of time. Having node information in a central place is important when scaling up the container creation mechanism itself. A single atomic request/operation in the database 720 is more efficient and can be performed by several container controllers in parallel.

In conclusion, embodiments in accordance with the present invention provide methods and systems for efficiently scheduling containers onto a set of nodes. If a single score value is computed using space-filling curves (SFCs), the exemplary methods can find a node with an optimal score by performing a range search and schedule a container onto this node, each with a single, very efficient lookup or request.

In general, when scheduling compute resources, orchestration systems like Kubernetes aim at distributing workload among all available nodes to minimize startup latency and maximize performance. This disregards the requirement of minimizing the amount of nodes used for scheduling and is not sufficiently flexible and fast for serverless cloud workloads.

In one instance, Google's Borg cluster management tries to both fill nodes densely while spreading load across nodes for large workload and during load spikes. Further, nodes preloaded with required programs and data are preferred during scheduling. However, such technique does not resolve the issues of the conventional art. Instead, the exemplary embodiments employ SFCs for encoding resource and metrics information in order to efficiently schedule containers onto a set of nodes. As noted above, if a single score value is computed using SFCs, the exemplary methods can find a node with an optimal score by performing a range search and schedule a container onto this node, each with a single, very efficient lookup or request.

Moreover, instead of scoring all available nodes upon each scheduling request, having all necessary data in a single place will significantly improve scheduling performance. If workloads can be fitted on a smaller number of nodes while keeping the same performance (e.g., without using interruptive methods such as pre-emption for moving workloads between nodes), that means a cloud provider can save costs. Being able to run user workloads independent of Kubernetes can be an advantage in non-Kubernetes environments or when using alternatives to pods or containers such as virtual machines, WebAssembly sandboxes, etc.

Therefore, the exemplary embodiments provide a plurality of virtual/physical servers (nodes), where at least one virtual/physical server (node) out of the plurality of nodes is available for computing resource creation/allocation. The exemplary embodiments further provide a database configured to store node information that is associated with the at least one virtual/physical server (e.g., score value, number of available resource units, currently running containers, number of containers currently created on the node, etc.). The exemplary embodiments also provide at least one computing resource controller configured to receive at least one computing resource creation request (container request) including required resource units for the computing resource.

The at least one computing resource controller is configured to generate a score value for each virtual/physical server (node) based upon the node information using space-filling curves indicative of computing resource creation availability and to store the score value in the database. Upon issuance of a respective computing resource creation request, the at least one computing resources controller is configured to select the at least one virtual/physical server for the allocation of computing resources in relation to score value information stored in the database and to update the score value to reflect allocation of computing resources during one/in the same atomic operation.

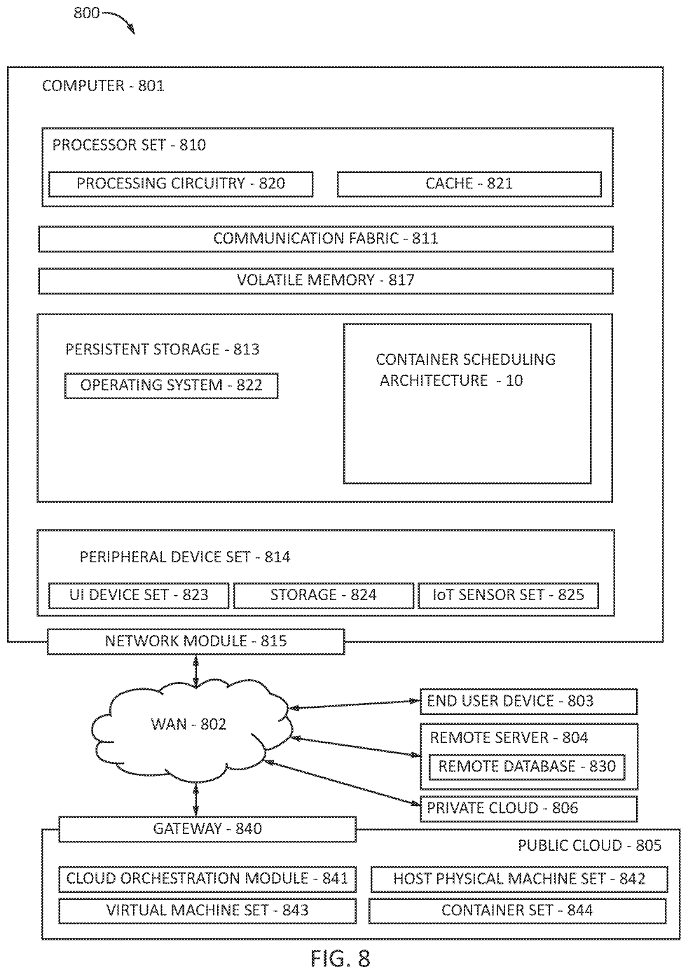

FIG. 8 is a block diagram of an exemplary computer system to apply the container scheduling architecture based on space-filling curves and a multi-dimensional resource model, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as the container scheduling architecture 10. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor—or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of methods and devices for container scheduling based on space-filling curves and a multidimensional resource model (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method comprising:
employing a plurality of container controllers to receive a plurality of container requests;
scheduling containers onto nodes that are available for container creation;
storing information pertaining to each of the nodes in a node score database, the information including at least a single score value computed by using space-filling curves (SFCs); and
finding a node with an optimal score by performing a range search to schedule a container of the containers to the node with the optimal score.

2. The method of claim 1, wherein each of the nodes has resources including at least memory, virtual central processing units (CPUs), and storage capacity to be divided among the containers.

3. The method of claim 1, wherein the plurality of container controllers schedule each of the plurality of container requests onto the nodes based on available resources.

4. The method of claim 1, wherein the node score database further stores the quantity of available units for each resource and metrics information.

5. The method of claim 4, wherein the metrics information includes a number of the containers currently created on the node with the optimal score.

6. The method of claim 1, wherein the nodes are virtual or physical servers.

7. The method of claim 1, wherein each resource and metric value of each of the nodes is atomically decremented when scheduling the containers.

8. A computer program comprising a computer readable storage medium having program instructions embodied therewith, the program instructions executable by a computer to cause the computer to:
employ a plurality of container controllers to receive a plurality of container requests;
schedule containers onto nodes that are available for container creation;
store information pertaining to each of the nodes in a node score database, the information including at least a single score value computed by using space-filling curves (SFCs); and
find a node with an optimal score by performing a range search to schedule a container of the containers to the node with the optimal score.

9. The computer program product of claim 8, wherein each of the nodes has resources including at least memory, virtual central processing units (CPUs), and storage capacity to be divided among the containers.

10. The computer program product of claim 8, wherein the plurality of container controllers schedule each of the plurality of container requests onto the nodes based on available resources.

11. The computer program product of claim 8, wherein the node score database further stores the quantity of available units for each resource and metrics information.

12. The computer program product of claim 11, wherein the metrics information includes a number of the containers currently created on the node with the optimal score.

13. The computer program product of claim 8, wherein the nodes are virtual or physical servers.

14. The computer program product of claim 8, wherein each resource and metric value of each of the nodes is atomically decremented when scheduling the containers.

15. A system comprising:
a memory; and
one or more processors in communication with the memory configured to:
employ a plurality of container controllers to receive a plurality of container requests;
schedule containers onto nodes that are available for container creation;
store information pertaining to each of the nodes in a node score database, the information including at least a single score value computed by using space-filling curves (SFCs); and
find a node with an optimal score by performing a range search to schedule a container of the containers to the node with the optimal score.

16. The system of claim 15, wherein each of the nodes has resources including at least memory, virtual central processing units (CPUs), and storage capacity to be divided among the containers.

17. The system of claim 15, wherein the plurality of container controllers schedule each of the plurality of container requests onto the nodes based on available resources.

18. The system of claim 15, wherein the node score database further stores the quantity of available units for each resource and metrics information.

19. The system of claim 18, wherein the metrics information includes a number of the containers currently created on the node with the optimal score.

20. The system of claim 15, wherein each resource and metric value of each of the nodes is atomically decremented when scheduling the containers.
